(19) United States
(12) Patent Application Publication
(10) Pub. No.: US 2012/0224224 A1
(43) Pub. Date: Sep. 6, 2012

(54) PRINTING APPARATUS AND PRINTING METHOD

(75) Inventors: Takayuki FURUMOTO, Shiojiri-shi (JP); Yuichi FURUWATA, Shiojiri-shi (JP)

(73) Assignee: SEIKO EPSON CORPORATION, Tokyo (JP)

(21) Appl. No.: 13/410,066

(22) Filed: Mar. 1, 2012

(30) Foreign Application Priority Data
Mar. 2, 2011 (JP) 2011-045538

(51) Int. Cl. G06F 3/12

(52) U.S. Cl. 358/1.15

(57) ABSTRACT

A printing apparatus according to the invention includes a reception section configured to receive a print job; a display section configured to display information relating to the received print job; and a printing execution section configured to execute printing based on the received print job. Further, the display section is further configured to, if a print job in an execution state exists, display information relating to a print job in a first display mode, and if a print job in a pausing state exists, display information relating to a print job in a second display mode which is different from the first display mode.

### BACKGROUND

1. Technical Field

The present invention relates to a printing apparatus and a printing method.

2. Related Art

Common printing apparatuses allow even a print job in an execution state to be cancelled if a cancellation operation regarding the print job is performed before printing processing regarding the print job has been completed (for example, refer to JP-A-2008-018622).

For example, such a printing apparatus is configured to, upon detection of pressing of a cancellation key while executing printing processing regarding a print job, causes the print job in an execution state to temporarily stop. Subsequently, the printing apparatus displays a list of all print jobs including print jobs in a print waiting state, and cancels print jobs a user has selected from among the listed print jobs.

However, depending on conditions, sometimes, it is not necessary to cause the print job in an execution state to temporarily stop. For example, if a user desires to cancel only any print job in a print waiting state, it is unnecessary to cause the print job in an execution state to temporarily stop.

### SUMMARY

An advantage of some aspects of the invention is to provide a technology which enables improvement of user-friendliness of cancellation operations with respect to print jobs.

A printing apparatus according to an aspect of the invention includes a reception section configured to receive a print job; a display section configured to display information relating to the received print job; and a printing execution section configured to execute printing based on the received print job. Further, the display section is further configured to, if a print job in an execution state exists, display information relating to a print job in a first display mode, and if a print job in a pausing state exists, display information relating to a print job in a second display mode which is different from the first display mode.

### BRIEF DESCRIPTION OF THE DRAWINGS

The invention will be described with reference to the accompanying drawings, wherein like numbers reference like elements.

FIG. 1 is a block diagram illustrating an example of an outline of a configuration of a printing system according to an embodiment of the invention.

FIG. 2 is a diagram illustrating an example of an operation panel according to an embodiment of the invention.

FIG. 3 is a diagram illustrating an example of a screen transition with respect to cancellation operations, according to an embodiment of the invention.

FIG. 4 is a diagram illustrating an example of a pop-up screen according to an embodiment of the invention.

### DESCRIPTION OF EXEMPLARY EMBODIMENTS

Hereinafter, an embodiment according to the invention will be described with reference to drawings.

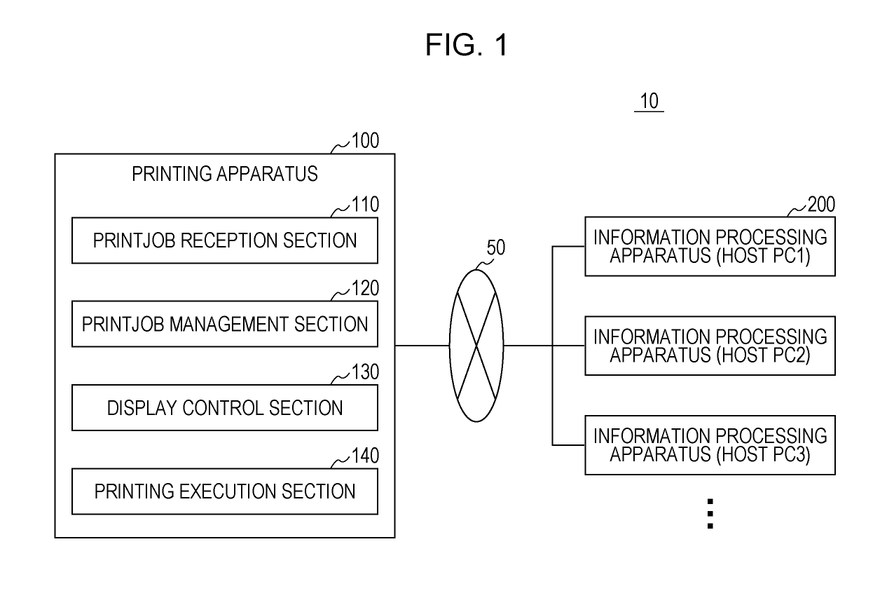

Referring to FIG. 1 which is a diagram illustrating an example of an outline of a configuration of a printing system 10 according to an embodiment of the invention, the printing system 10 includes a printing apparatus 100 and an information processing apparatus (a host PC) 200.

The printing apparatus 100 and the information processing apparatus 200 are connected to each other via a computer network 50, such as a local area network (LAN), so as to be mutually communicable.

The printing apparatus 100 performs printing processing on print data having been transmitted from the information processing apparatus 200. The printing apparatus 100 is a common printer which includes the following units and devices (not illustrated): a central processing unit (CPU); a main storage device such as random access memory (RAM); an external storage device such as read only memory (ROM) and flash memory; a communication device interfaced with the computer network 50; and a printing engine.

Moreover, the printing apparatus 100 further includes an operation panel (an input and output device) 121 consisting of input buttons, a touch panel, a liquid crystal display panel and the like.

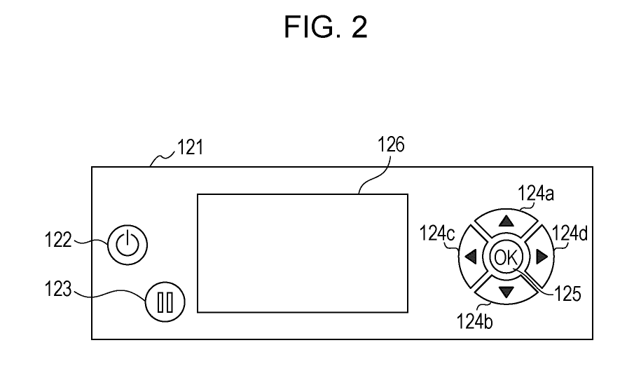

Referring to FIG. 2 which is a diagram illustrating an example of the operation panel 121, the operation panel 121 includes the following buttons and keys disposed thereon: a power button 122; a cancellation (pause) button 123; direction keys (i.e., an up-direction key 124a, a down-direction key 124b, a left-direction key 124c and a right-direction key 124d); an OK button 125; and a display 126.

The power button is a button for tuning on the power of the printing apparatus 100. The cancellation button 123 is a button for causing a print job in an execution state to pause. The direction keys (124a to 124d) are keys for switching a screen which is currently displayed on the display 126 (i.e., keys for, for example, scrolling pieces of information X relating to print jobs). The OK button 125 is a key for selecting a print job or selecting a highlighted item. The display 126 displays various pieces of information (for example, the pieces of information X relating to print jobs).

Further, as described in FIG. 1, the printing apparatus 100 includes a print job reception section 110, a print job management section 120, a display control section 130, and a printing execution section 140. In addition, the functions of the above-described function sections (110 to 140) can be realized by loading prescribed programs to the main storage device and causing the CPU to execute the loaded programs.

The print job reception section 110 receives print jobs having been outputted from the information processing apparatus 200. Further, the print job reception section 110 stores the received print jobs into a prescribed storage device.

The print job management section 120 manages the print jobs having been received by the print job reception section 110. For example, the print job management section 120 analyzes each of the print jobs having been received by the print job reception section 110, and creates the piece of information X relating to the print job (hereinafter, which will be also called just “the piece of information X”). Here, the piece of information X relating to a print job includes the name of the print job, which identifies the print job (or the name of a file), the name of a device which has created the print job (or the name of a user), a print setting (for example, the size of print paper), the number of print copies, and the like.

Further, the print job management section 120 determines an execution priority order for each of print jobs. Usually, the print job management section 120 handles a reception order of a received print job as the execution priority order therefor without any change. But, in the case where any change in determination of the execution priority order for a certain print job is instructed by a user (for example, in the case of an interruption print job), the print job management section 120 changes the execution priority order for the print job in accordance with the instruction.

Moreover, the print job management section 120 deletes a print job, regarding which printing processing has been completed, from the prescribed storage device.

The display control section 130 performs control of screens which are displayed on a prescribed outputting device (for example, the display 126). For example, the display control section 130 displays the pieces of information X having been created by the print job management section 120.

Here, if a print job in an execution state exists, the display control section 130 displays the piece of information X relating to each of print jobs in a first display mode, which will be hereinafter described in detail. Further, if a print job in a pausing state exists, the display control section 130 displays the piece of information X relating to each of print jobs in a second display mode (which will be described below in detail) different from the first display mode. Moreover, when a certain print job is selected, the display control section 130 displays the piece of information X relating to the selected print job in a third display mode (which will be described below in detail) different from the second display mode.

The printing execution section 140 executes printing processing based on attributes of each of print jobs. Specifically, the printing execution section 140 extracts a print command and data targeted for printing from each of print jobs having been transmitted from the information processing apparatus 200, and on the basis of the print command and the data targeted for printing, creates a block of print data whose size does not exceed a maximum size of print data which can be print-processed by the printing engine. Subsequently, the printing execution section 140 transmits the block of print data to the printing engine, and performs control so as to cause the printing engine and a printing head (not illustrated) to execute printing processing based on the attributes of the print job onto a printing medium (for example, print paper).

In addition, the configuration elements of the printing apparatus 100 are not limited to the above-described configuration elements, which are just main configuration elements in description of the characteristics of the invention. Further, the above-described configuration elements of the printing apparatus 100 do not remove any other configuration elements included in common printers. Moreover, the printing apparatus 100 may be replaced by a different type apparatus having a printing function, such as a scanner, a multi-functional device, or a facsimile machine.

Moreover, the information processing apparatus 200 functions as a host computer for the printing apparatus 100. As shown in FIG. 1, the computer network 50 is connected to a plurality of the information processing apparatuses 200. Further, the information processing apparatuses 200 are capable of transmitting print jobs mutually independently to the printing apparatus 100.

The information processing apparatus 200 is a common computer which includes the following units and devices (not illustrated): a CPU; a main storage device such as RAM; an external storage device such as ROM and a hard disc; an output device such as a display; an input device such as a keyboard and a mouse device; and a communication interface for transmitting and receiving data to/from the printing apparatus 100.

In addition, the configuration elements of the information processing apparatus 200 are not limited to the above-described configuration elements, which are just main configuration elements in description of the characteristics of the invention. Further, the above-described configuration elements of the information processing apparatus 200 do not remove any other configuration elements included in common computers. Moreover, the information processing apparatus 200 may be replaced by a different type apparatus functioning as a host computer for the printing apparatus 100, such as a mobile terminal.

The printing system 10 according to this embodiment is configured in such a way as described above. In addition, the configuration elements of the printing system 10 are not limited to the above-described configuration elements, which are just main configuration elements in description of the characteristics of the invention. Further, the above-described configuration elements of the printing system 10 do not remove any additions of other configuration elements.

Further, the above-described configuration elements are ones which result from classifying a processing configuration of the printing system 10 on the basis of individual key processing configurations thereof, in order to make it easy to understand the configuration of the printing system 10. In addition, the scope of the invention is not limited by any way of classification of the processing configuration thereof into configuration elements, and any names of respective configuration elements resulting from the classification. The processing configuration of the printing apparatus 10 can be classified into more configuration elements on the basis of individual smaller key processing configurations thereof. Moreover, the processing configuration of the printing apparatus 10 can be classified into configuration elements so that each of the configuration elements can execute more processes. Furthermore, processes of each configuration element may be executed by just a hardware element or by a plurality of hardware elements.

Next, characteristic operations of the printing system 10 configured in such a way as described above will be described.

### Display Control

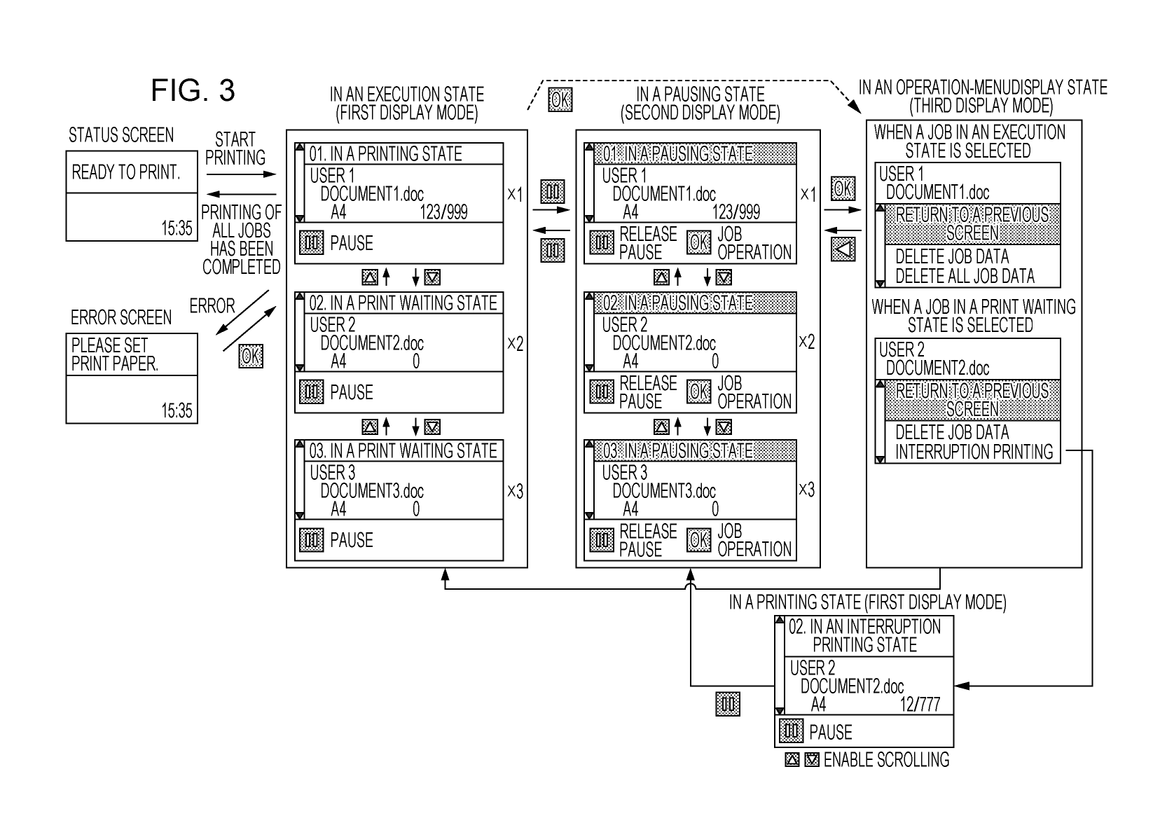

FIG. 3 is a diagram illustrating an example of a screen transition controlled by the display control unit 130.

While waiting for a print job to be transmitted from the information processing apparatus 200, the display control unit 130 displays a status screen on the display 126. Here, the status screen is provided thereon with, for example, a message, “READY TO PRINT”, which notifies users of a current condition where the printing apparatus 100 is ready to print, a current clock time, and the like.

Further, upon reception of a print job having been transmitted from the information processing apparatus 200, the print job reception section 110 stores the print job into a prescribed storage device, and further, notifies the individual function sections (120 to 140) of the reception of the print job.

Upon reception of the notification, the print job management section 120 analyzes the print job having been received by the print job reception section 110, and then, creates the piece of information X relating to the received print job.

Further, the print job management section 120 determines an execution priority order for the print job having been received by the print job reception section 110. For example, in the case where any print job in an execution state (or in a print waiting state) other than the print job having been received by the print job reception section 110 does not exist, the print job management section 120 determines the received print job as a print job to be executed first. In contrast, in the case where any print job in an execution state (or in a print waiting state) other than the print job having been received by the print job reception section 110 exists, the print job management section 120 determines the received print job as a print job to be executed last. In addition, every time printing processing regarding a print job has been completed, the print job management section 120 upgrades an execution priority order of each of print jobs in a print waiting state by one. That is, the print job management section 120 replaces a current execution priority order of each of print jobs in a print waiting state by “(the current execution priority order)−“1””.

Further, the printing execution section 140 starts execution processing regarding a print job which has been determined as a pint job to be executed first. Specifically, the printing execution section 140 extracts a print command and data targeted for printing from a print job which has been determined as a pint job to be executed first, and on the basis of the print command and the data targeted for printing, creates a block of print data whose size does not exceed a maximum size of print data which can be print-processed by the printing engine. Subsequently, the printing execution section 140 transmits the block of print data to the printing engine, and performs control so as to cause the printing engine and the printing head to execute printing processing based on the attributes of the print job onto a printing medium (for example, print paper).

In addition, even after execution processing regarding a print job has been started, it is possible to cancel the print job if a cancellation operation is performed before all blocks of print data having been created on the basis of the attributes of the print job have been completely transmitted to the printing engine.

### First Display Mode: Screen in an Execution State

For example, when execution processing regarding a print job is started by the printing execution section 140, the display control section 130 displays a screen in an execution state on the display 126, such as shown in FIG. 3, (the above-described first display mode).

Here, the screen in an execution state includes, for example, the piece of information X having been created by the print job management section 120. In an example thereof shown in FIG. 3, as the piece of information X relating to a print job in an execution state, the following items are displayed on the display 126: a message which indicates that the print job is in a printing state, “01. IN A PRINTING STATE”; the name of a user who has created the print job, “USER 1”; a file name which identifies the print job, “DOCUMENT 1.doc”; the size of print paper, having been specified, “A4”; the number of print copies, “999”, and the like.

Further, in the case where, besides a print job in an execution state, any print job in a print waiting state exists (in an example shown in FIG. 3, two print jobs in a print waiting state exist), the display control section 130 can display the piece of information X relating to each of the print jobs in a print waiting state in response to any scroll operation performed by a user.

For example, upon detection of pressing of the down-direction key 124b under the condition where a piece of information X1 relating to a print job in an execution state is displayed, the display control section 130 performs switching of the currently displayed screen to a screen (that is, the display control section 130 causes the currently displayed screen to scroll downward to a screen), on which a piece of information X2 relating to a print job in a print waiting state is displayed. In an example thereof shown in FIG. 3, as the piece of information X2 relating to a print job in a print waiting state, the following items are displayed on the display 126: a message which indicates that the print job is in a print waiting state, “02. IN A PRINT WAITING STATE”; the name of a user who has created the print job, “USER 2”; a file name which identifies the print job, “DOCUMENT 2.doc”; the size of a print paper, having been specified, “A4”, and the like.

Further, upon further detection of pressing of the down-direction key 124b under the condition where the piece of information X2 relating to a print job in a print waiting state is displayed, the display control section 130 performs switching of the currently displayed screen to a screen (that is, the display control section 130 causes the currently displayed screen to scroll downward to a screen), on which a piece of information X3 relating to another print job in a print waiting state is displayed. In an example thereof shown in FIG. 3, the following items are displayed on the screen 126: a message which indicates that the print job is in a print waiting state, “03. IN A PRINT WAITING STATE”; the name of a user who has created the print job, “USER 3”; a file name which identifies the print job, “DOCUMENT 3.doc”; the size of a print paper, having been specified, “A4”, and the like.

Further, upon detection of pressing of the up-direction key 124a under the condition where the piece of information X (the piece of information X2 or the piece of information X3) relating to a print job in a print waiting state is displayed, the display control section 130 returns the currently displayed screen (that is, the display control section 130 causes the currently displayed screen to scroll upward) to the immediately previously displayed screen (on which the piece of information X1 or the piece of information X2 has been displayed).

By displaying such screens in an execution state (that is, by displaying the piece of information X relating to each of print jobs in the first display mode), the printing apparatus 100 can receive a selection of any print job in an execution state or in a print waiting state without causing the print job in an execution state to pause (temporarily stop). In addition, the selection of any print job in an execution state or in a print waiting state can be realized by pressing the cancellation (pause) button 123 or the OK button 125.

Further, on a screen in an execution state, the piece of information X relating to each print job can be displayed in response to any scroll operation performed by a user, and thus, it is possible to display the piece of information X on the whole area of the display 126; thereby enabling display of more details of information relating to each print job on the display 126. As a result, a user can certainly select any print job the user desires to cancel or the like.

Meanwhile, in the case where any error occurs in the printing apparatus 100 under the condition where the piece of information X is displayed in the first display mode (that is, under the condition where a screen in an execution state is displayed), an error screen shown in FIG. 3 is displayed on the display 126. Here, the error screen includes, for example, a message which notifies users of an error having occurred in the printing apparatus 100 (the message being, for example, “PLEASE SET PRINT PAPER”), and the like.

Further, in the case where printing processing regarding all jobs has been completed under the condition where the piece of information X relating to a print job is displayed in the first display mode (that is, under the condition where a screen in an execution state is displayed), the display control section 130 returns the currently displayed screen to the status screen.

### Second Display Mode: Screen in a Pausing State

Further, upon detection of pressing of the cancellation button 123 under the condition where a piece of information relating to a print job (any of the pieces of information X1 to X3) is displayed in the first display mode (that is, under the condition where a screen in an execution state is displayed), the display control section 130 recognizes that the currently displayed print job has been selected, and displays a corresponding screen in a pausing state, shown in FIG. 3, on the display 126 (the above-described second display mode).

Subsequently, the printing execution section 140 causes execution processing being performed regarding a print job in an execution state to pause (temporarily stop).

A screen in a pausing state includes the piece of information X which has been created by the print job management section 120, just like a screen in an execution state. For example, the printing control section 130 displays a piece of information (any of the pieces of information X1 to X3) relating to a print job, which has been selected on a display in an execution state, on a corresponding screen in a pausing state as well.

In this regard, however, the way of displaying a screen in a pausing state (i.e., the second display mode) is different from the way of displaying a screen in an execution state (i.e., the first display mode) in a respect in which a message, “01. IN A PAUSING STATE”, which indicates that a current state is a pausing state, is highlight-displayed.

Further, just like the way of displaying a screen in an execution state (i.e., the first display mode), in the case where at least one print job in a print waiting state exists (in an example shown in FIG. 3, two print jobs in a print waiting state exist), the display control section 130 can display the piece of information X relating to each of print jobs, which is in a pausing state or in a print waiting state, in response to any scroll operation performed by a user.

By displaying such screens in a pausing state (that is, by displaying the piece of information X relating to each of print jobs in the second display mode) under the condition where a print job in an execution state is caused to pause (temporarily stop), the printing apparatus 100 according to this embodiment can receive a selection of any print job in a pausing state or in a print waiting state. In addition, the selection of any of print jobs in a pausing state or in a print waiting state can be realized by pressing the OK button 125.

In addition, upon detection of pressing of the cancellation button 123 under the condition where the piece of information X relating to a print job is displayed in the second display mode (that is, under the condition where a screen in a pausing state is displayed), the display control section 130 recognizes that an instruction for releasing the pausing state has been made, and returns the currently displayed screen to a screen in an execution state (the first display mode). At the same time, the printing execution section 140 resumes execution processing regarding the print job which has been in the pausing state.

### Third Display Mode: Screen in an Operation-Menu Display State

Further, upon detection of pressing of the OK button 125 under the condition where a piece of information relating to a print job (any of the pieces of information X1 to X3) is displayed in the second display mode (that is, under the condition where a screen in a pausing state is displayed), the display control section 130 recognizes that the currently displayed print job has been selected, and displays a corresponding screen in an operation-menu display state, shown in FIG. 3, on the display 126 (the above-described third display mode).

Here, the screen in an operation-menu display state includes, for example, operation items to be performed with respect to a print job which has been selected on a screen in a pausing state (or on a screen in an execution state), in addition to the piece of information X relating to the print job, which has been created by the print job management section 120.

For example, as shown in FIG. 3, in the case where a print job in a pausing state is selected on a screen in a pausing state, the printing control section 130 displays the name of a user who has created the print job, “USER 1”, and a file name which identifies the print job, “DOCUMENT 1. doc”, and further, displays “RETURN TO A PREVIOUS SCREEN”, “DELETE JOB DATA”, “DELETE ALL JOB DATA” and the like, as operation items to be performed with respect to the print job having been selected.

Meanwhile, in the case where a print job in a print waiting state is selected on a screen in a pausing state, the printing control section 130 displays the name of a user who has created the print job, “USER 2”, and a file name which identifies the print job, “DOCUMENT 2.doc”, and further, displays “RETURN TO A PREVIOUS SCREEN”, “DELETE JOB DATA”, “INTERRUPTION PRINTING” and the like, as operations items to be performed with respect to the print job having been selected.

Here, in the case where “RETURN TO A PREVIOUS SCREEN” is selected (or in the case where the left-direction key 124c is pressed), the display control section 130 returns the currently displayed screen to a screen in a pausing state (the second display mode).

Further, in the case where “DELETE JOB DATA” is selected, the display control section 130 deletes a print job having been selected on a screen in a pausing state, and returns the currently displayed screen to a screen in an execution state (the first display mode). In addition, when any print job to be executed does not exist, the display control section 130 returns the currently displayed screen to the status screen.

Further, in the case where “DELETE ALL JOB DATA” is selected, the display control section 130 deletes a print job having been selected on a screen in a pausing state, as well as all other print jobs, and returns the currently displayed screen to the status screen.

Further, in the case where “INTERRUPTION PRINTING” is selected, the display control section 130 returns the currently displayed screen to a screen in an execution state (the first display mode), and displays the piece of information X relating to a print job, for which the interruption printing has been instructed, on the display 126. Here, the printing execution section 130 executes the interruption print job as a print job having the highest priority (this is a so-called interruption printing). In this case, if a print job in a pausing state exists, the printing execution section 130 aborts execution processing regarding this print job. Moreover, the print job management section 120 downgrades an execution priority order of each of print jobs other than the print job having the highest priority by one (that is, the print job management section 120 replaces a current execution priority order of each of print jobs other than the print job having the highest priority by “(the current execution priority order)+“1””.

In addition, even after the “INTERRUPTION PRINTING” has been selected on a screen in an operation-menu display state, and thereby, the currently displayed screen has been moved to a screen in an execution state, in the case where any print job in a print waiting state exists, the display control section 130 can display the piece of information X relating to each of print jobs in response to any scroll operation performed by a user.

Further, upon detection of pressing of the OK button 125 under the condition where a piece of information (any of the pieces of information X1 to X3) relating to a print job is displayed in the first display mode (that is, under the condition where a screen in an execution state is displayed), the display control section 130 may also recognize that the currently displayed print job has been selected, and may cause the currently displayed screen to transit to a screen in an operation-menu display state without causing the currently displayed screen to transit to a screen in a pausing state (such as denoted by the arrow in a dotted line shown in FIG. 3). In this case, it is possible to cause the currently displayed screen to transit to a screen in an operation-menu display state without causing the print job in an execution state to pause (temporarily stop).

Further, after the transition to a screen in an operation-menu display state has been performed in such a way as described above (i.e., after the transition from a screen in the first display mode to a screen in the third display mode has been performed), upon detection of selection of “RETURN TO A PREVIOUS SCREEN” (or pressing of the left-direction key 124c), the display control section 130 returns a currently displayed screen to a screen in an execution state (i.e., in the first display mode).

Further, in the case where “DELETE JOB DATA” is selected, the display control section 130 deletes a print job which has been selected on a screen in an execution state, and returns the currently displayed screen to a screen in an execution state (i.e., in the first display mode). In this way, it is possible to delete any print job in a print waiting state without causing a print job in an execution state to pause (temporarily stop) at all.

Further, in the case where “DELETE ALL JOB DATA” is selected, the display control section 130 deletes all print jobs, in addition to a print job having been selected on a screen in an execution state, and then, returns the currently displayed screen to the status screen.

Further, in the case where “INTERRUPTION PRINTING” is selected, the display control section 130 returns the currently displayed screen to a screen in an execution state (i.e., in the first display mode), and displays the piece of information X relating to the print job, for which interruption printing has been instructed, on the display 126. Here, the printing execution section 130 executes the print job, for which interruption printing has been instructed, as a print job having the highest priority (this is a so-called interruption printing). In this case, when a print job in an execution state already exists, the printing execution section 130 aborts execution processing being performed regarding the print job. Further, the print job management section 120 downgrades an execution priority order of each of print jobs other than the print job having the highest priority by one (that is, the print job management section 120 replaces a current execution priority order of each of print jobs other than the print job having the highest priority by “(the current execution priority order)+“1””).

Such a display control as described above enables improvement of user-friendliness of cancellation operations regarding print jobs in the printing apparatus 100 according to this embodiment.

For example, it is possible to select each of print jobs, confirm information relating to each of print jobs, and the like, without causing a print job in an execution state to pause (temporarily stop). Moreover, it is also possible to cancel only any print job in a print waiting state without causing a print job in an execution state to pause (temporarily stop). This method absolutely prevents occurrence of inconvenience in which a user's own print job is caused to pause (temporarily stop) because of any other users' cancellation operations regarding print jobs thereof.

Further, it is also possible to, after having caused a print job in an execution state to pause (temporarily stop), select print jobs targeted for cancellation at an easy pace. This method enables prevention of occurrence of inconvenience in which, while selecting print jobs targeted for cancellation, a print job in an execution state has disappeared (that is, printing processing regarding a print job in an execution state has been completed).

Further, the above-described embodiment is intended to exemplify the gist of the invention, and does not limit the scope of the invention. Lots of alternatives, modifications and changes are obvious for those skilled in the art.

For example, on a screen in an execution state (in the first display mode), the display control section 130 may display the piece of information X relating to each of previously completed print jobs (that is, history information), in addition to a print job in an execution state and each of print jobs in a print waiting state, in response to any scroll operation performed by a user.

Further, on a screen in a pausing state (in the second display mode) as well, the display control section 130 may display the piece of information X relating to each of previously completed print jobs (that is, history information), in addition to a print job in an execution state and each of print jobs in a print waiting state, in response to any scroll operation performed by a user.

Further, prior to display of a screen in a pausing state, the display control section 130 may highlight-display a message indicating that a print job in an execution state has been caused to pause.

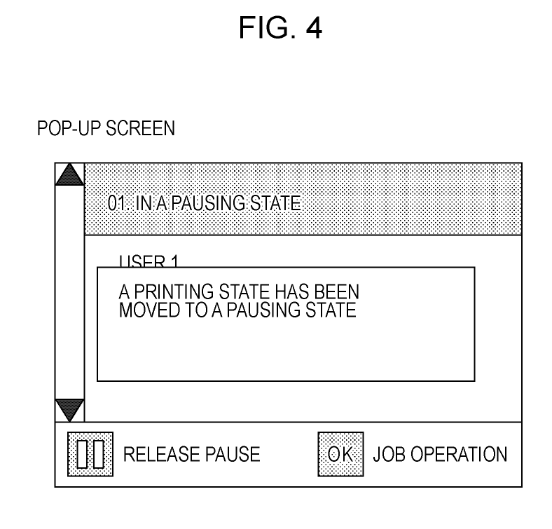

As shown in FIG. 4 which is a diagram illustrating an example of a pop-up screen on which a message indicating that a print job in an execution state has been caused to pause, the display control section 130 may display a pop-up screen, on which a message, “A PRINTING STATE HAS BEEN MOVED TO A PAUSING STATE” is indicated, prior to display of a screen in a pausing state. In this way, users can know with certainty that a print job in an execution state has been caused to pause (temporarily stop).

Further, the operation panel 121 is not limited to the above-described configuration according to this embodiment, but may be configured to include substitute buttons and keys.

The entire disclosure of Japanese Patent Application No. 2011-045538, filed Mar. 2, 2011 is expressly incorporated by reference herein.

What is claimed is:

1. A printing apparatus comprising:
a reception section configured to receive a print job;
a display section configured to display information relating to the received print job; and
a printing execution section configured to execute printing based on the received print job,
wherein the display section is further configured to, if a print job in an execution state exists, display information relating to a print job in a first display mode, and if a print job in a pausing state exists, display information relating to a print job in a second display mode which is different from the first display mode.

2. The printing apparatus according to claim 1, wherein the display section is further configured to, when the reception section receives a print job, perform switching to a display in the first display mode.

3. The printing apparatus according to claim 1, further comprising:
a command reception section configured to receive a command from a user,
wherein the display section is configured to, while displaying information relating to a print job in an execution state in the first display mode, if the command reception section receives a command for executing a scrolling operation, perform switching to a display of information relating to a different print job in a print waiting state, and while displaying information relating to a print job in a pausing state in the second display mode, if the command reception section receives a command for executing a scrolling operation, perform switching to a display of information relating to a different print job in a print waiting state.

4. The printing apparatus according to claim 1, further comprising:
a command reception section configured to receive a command from a user,
wherein the display section is configured to, while displaying information relating to a print job in an execution state in the first display mode, if the command reception section receives a command for executing a pausing operation, perform switching to a display in the second display mode.

5. The printing apparatus according to claim 1, further comprising:
a command reception section configured to receive a command from a user,
wherein the display section is configured to, while displaying information relating to a print job in a pausing state in the second display mode, if the command reception section receives a command for selecting a print job, display information relating to the selected print job in a third display mode which is different from the second display mode.

6. The printing apparatus according to claim 5, wherein the printing execution section is configured to, while information relating to a print job is displayed in the third display mode, if the command reception section receives a command for deleting a print job, delete the print job.

7. The printing apparatus according to claim 5, wherein the printing execution section is configured to, while information relating to a print job is displayed in the third display mode, if the command reception section receives a command for executing an interruption print job, execute the interruption print job as a print job having the highest priority.

8. The printing apparatus according to claim 1, further comprising:
a command reception section configured to receive a command from a user,
wherein the display section is configured to, while displaying information relating to a print job in an execution state in the first display mode, if the command instruction section receives a command for executing a pausing operation, perform switching to a display in a third display mode which is different from the second display mode.

9. A printing method comprising:
reception of a print job;
display of information relating to the received print job; and
execution of printing based on the received print job,
wherein, in the display of information relating to the received print job, if a print job in an execution state exists, information relating to a print job is displayed in a first display mode, and if a print job in a pausing state exists, information relating to a print job is displayed in a second display mode which is different from the first display mode.

10. The printing method according to claim 9, wherein, in the display of information relating to the received print job, when a print job is received in the reception of a print job, switching to a display in the first display mode is performed.

11. The printing method according to claim 9, further comprising:
reception of a command from a user,
wherein, in the display of information relating to the received print job, while information relating to a print job in an execution state is displayed in the first display mode, if a command for executing a scrolling operation is received in the reception of a command from a user, switching to a display of information relating to a different print job in a print waiting state is performed, and while information relating to a print job in a pausing state is displayed in the second display mode, if a command for executing a scrolling operation is received in the reception of a command from a user, switching to a display of information relating to a different print job in a print waiting state is performed.

12. The printing method according to claim 9, further comprising:
reception of a command from a user,
wherein, in the display of information relating to the received print job, while information relating to a print job in an execution state is displayed in the first display mode, if a command for executing a pausing operation is received in the reception of a command from a user, switching to a display in the second display mode is performed.
